(19) United States
(12) Patent Application Publication
(10) Pub. No.: US 2026/0288059 A1
(43) Pub. Date: Sep. 24, 2026

(54) IMAGE FORMING SYSTEM

(71) Applicant: FUJIFILM Business Innovation Corp., Tokyo (JP)

(72) Inventors: Tatsuro MATSUOKA, Kanagawa (JP); Kazunari ISHII, Kanagawa (JP); Yuka NOMURA, Kanagawa (JP); Maho ITAKURA, Kanagawa (JP); Natsuki OGAWA, Kanagawa (JP); Narumi NAKAYA, Kanagawa (JP)

(73) Assignee: FUJIFILM Business Innovation Corp., Tokyo (JP)

(21) Appl. No.: 19/261,992

(22) Filed: Jul. 7, 2025

(30) Foreign Application Priority Data
Mar. 24, 2025 (JP) 2025-049114

(51) Int. Cl. G03G 21/20; G03G 21/10; G03G 21/12

(52) U.S. Cl. CPC G03G 21/206; G03G 21/105; G03G 21/12; G03G 2221/0005; G03G 2221/1645

(57) ABSTRACT

An image forming system includes an image forming unit that forms an image on a medium by using toner, a cyclone capturing unit that includes a suction port through which air containing the toner in the image forming unit is sucked, a tubular container in which the air sucked through the suction port is swirled and of which at least a lower portion is provided with an inclination at which an inner diameter of the container gradually increases from a lower portion side toward an upper portion side, a collection portion that collects the toner, and a gas outlet port for discharge of the air and in which the air is swirled in the container such that the toner is separated from the air due to a centrifugal force, the toner is captured and collected into the collection portion, and the air is discharged through the gas outlet port, plural cleaning members that are accommodated in the container and that are swirlable together with the air, and a holding member that is provided at at least a lower end portion of the inclination of the container and that holds the plural cleaning members in the container.

### CROSS-REFERENCE TO RELATED APPLICATIONS

This application is based on and claims priority under 35 USC 119 from Japanese Patent Application No. 2025-049114 filed Mar. 24, 2025.

### BACKGROUND

### (i) Technical Field

The present invention relates to an image forming system.

### (ii) Related Art

Disclosed in JP2018-196863A is a paint collection device including a cyclone container, an air blowing device, and a cleaning member. The cyclone container includes a gas inlet port, a processing space for processing of paint mist sucked through the gas inlet port, and a gas outlet port leading into the processing space. The air blowing device generates, in the processing space of the cyclone container, an air stream flowing toward the gas outlet port from the gas inlet port. The cleaning member is inserted into the processing space of the cyclone container. The cleaning member is configured such that the air stream generated by the air blowing device swirls the cleaning member along an inner wall of the cyclone container after the cleaning member is inserted into the processing space.

Disclosed in JP2018-196864A is a paint collection device including a cyclone container, an air blowing device, a scraping member, and a driving device. The cyclone container includes a gas inlet port, a processing space for centrifugal separation of paint mist sucked through the gas inlet port in which the paint mist is separated into paint and air, and a gas outlet port through which the air is discharged from the processing space. The air blowing device generates, in the processing space of the cyclone container, an air stream flowing toward the gas outlet port from the gas inlet port. The scraping member is provided in the processing space of the cyclone container. The driving device drives at least one of the scraping member or the cyclone container such that the scraping member scrapes off paint accumulating on an inner wall of the cyclone container.

Disclosed in JP2002-055583A is a toner collecting device of an electrophotographic apparatus that includes a cyclone dust collector, a dust collection chamber, a toner collection container, and toner accumulation amount detection sensors, and opening and closing valves. The cyclone dust collector is connected to a cleaning device for untransferred toner on a photoreceptor. The dust collection chamber is connected to a lower portion of the cyclone dust collector. The toner collection container is an attachable and detachable collection container connected to a lower portion of the dust collection chamber. A plurality of toner accumulation amount detection sensors are disposed at a side surface of the dust collection chamber. The opening and closing valves are disposed at a lower portion of a cyclone and the lower portion of the dust collection chamber. In the toner collecting device, a cleaning member that rotates along an inner wall of the dust collection chamber is provided at a position at which the cleaning member can clean the toner accumulation amount detection sensors.

### SUMMARY

Aspects of non-limiting embodiments of the present disclosure relate to an image forming system with which it is possible to suppress adhesion of toner onto a wall surface of a cyclone capturing unit in comparison with a case where only air containing toner is caused to swirl in the cyclone capturing unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system includes an image forming unit that forms an image on a medium by using toner, a cyclone capturing unit that includes a suction port through which air containing the toner in the image forming unit is sucked, a tubular container in which the air sucked through the suction port is swirled and of which at least a lower portion is provided with an inclination at which an inner diameter of the container gradually increases from a lower portion side toward an upper portion side, a collection portion that collects the toner, and a gas outlet port for discharge of the air and in which the air is swirled in the container such that the toner is separated from the air due to a centrifugal force, the toner is captured and collected into the collection portion, and the air is discharged through the gas outlet port, a plurality of cleaning members that are accommodated in the container and that are swirlable together with the air, and a holding member that is provided at at least a lower end portion of the inclination of the container and that holds the plurality of cleaning members in the container.

### BRIEF DESCRIPTION OF THE DRAWINGS

Exemplary embodiment(s) of the present invention will be described in detail based on the following figures, wherein:

FIG. 1 is a schematic configuration view showing an example of a configuration of an image forming system according to a first exemplary embodiment;

FIG. 2 is a schematic configuration view showing an example of an image forming unit of the image forming system according to the first exemplary embodiment;

FIG. 3A is a perspective view that shows an example of a cyclone device in the image forming system according to the first exemplary embodiment and that shows a state where a gas discharge fan is driven;

FIG. 3B is a perspective view showing the way in which air and toner flow in the cyclone device in the image forming system according to the first exemplary embodiment;

FIG. 4 is a perspective view that shows an example of the cyclone device in the image forming system according to the first exemplary embodiment and that shows a state where the gas discharge fan is stopped;

FIG. 5 is a block diagram showing an example of a hardware configuration of the image forming system according to the first exemplary embodiment;

FIG. 6 is a view for description of the behavior of a cleaning member in a cyclone container of the cyclone device;

FIG. 7 is a view for description of a relationship between a wind speed in the cyclone container of the cyclone device and the position of the cleaning member;

FIG. 8 is a diagram showing a triboelectric series for selection of a material constituting the cleaning member;

FIG. 9A is a configuration view showing a first example of a holding member used in the cyclone device;

FIG. 9B is a configuration view showing a second example of the holding member used in the cyclone device;

FIG. 9C is a configuration view showing a third example of the holding member used in the cyclone device;

FIG. 10 is a perspective view showing an example of a cyclone device used in an image forming system according to a second exemplary embodiment;

FIG. 11 is a perspective view showing an example of a cyclone device used in an image forming system according to a third exemplary embodiment; and

FIG. 12 is a graph for comparison between a toner capturing rate of a filter and a toner capturing rate of a cyclone.

### DETAILED DESCRIPTION OF THE INVENTION

Hereinafter, exemplary embodiments of the present invention will be described. In the following description, a direction represented by an arrow H in the drawings will be referred to as a vertical direction, and a direction represented by an arrow W will be referred to as a horizontal direction, which is an apparatus width direction.

### First Exemplary Embodiment

First, an overall configuration of an image forming system according to a first exemplary embodiment will be described. Thereafter, a configuration of a cyclone device used in the image forming system will be described.

### Overall Configuration of Image Forming System

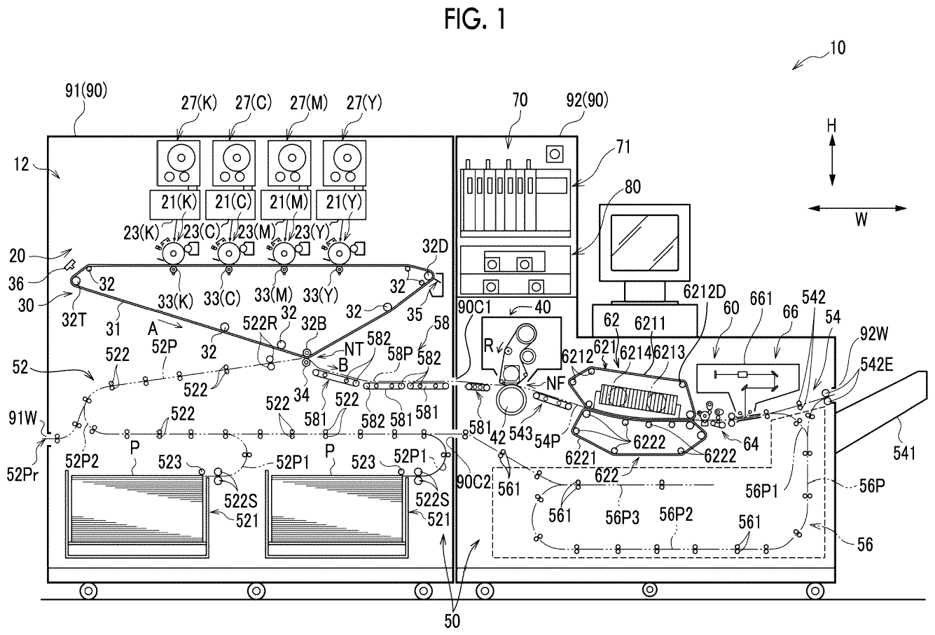

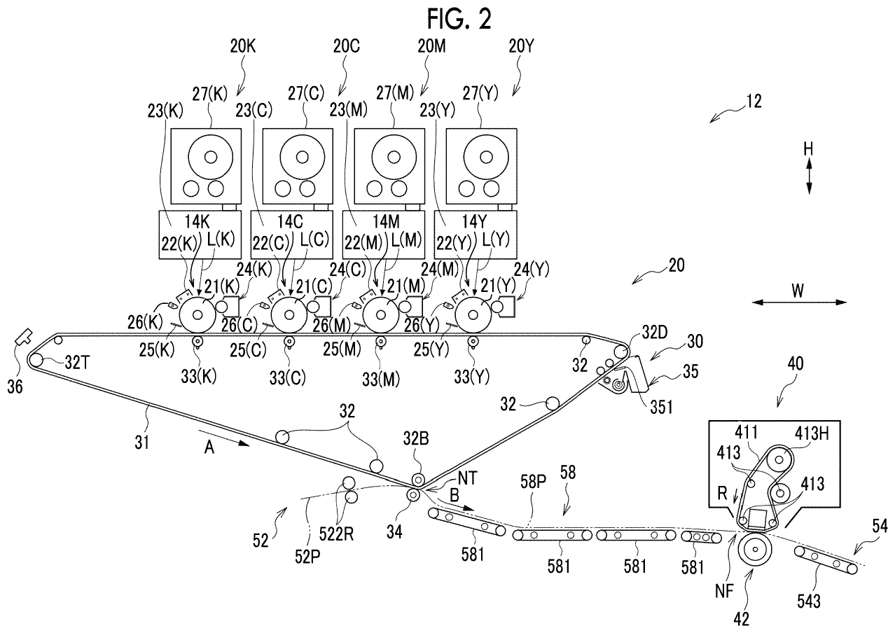

FIG. 1 is a schematic configuration view showing an example of a configuration of the image forming system according to the first exemplary embodiment. FIG. 2 is a schematic configuration view showing a configuration of an image forming unit of the image forming system shown in FIG. 1.

As shown in FIG. 1, an image forming system 10 includes an image forming unit 12 that electrophotographically forms an image on a recording medium P which is an example of a medium, a medium transportation device 50 that transports the recording medium P, and a postprocessing unit 60 that performs postprocessing or the like of the recording medium P on which the image is formed. In addition, the image forming system 10 includes a power supply unit 80 that supplies power to each part of an apparatus and a control unit 70 that controls each part of the apparatus.

The image forming unit 12 includes toner image forming units 20 that form toner images, a transfer device 30 that transfers the toner images formed by the toner image forming units 20 to the recording medium P, and a fixing device 40 that fixes, onto the recording medium P, the toner images transferred to the recording medium P.

The medium transportation device 50 includes a medium supply unit 52 that supplies the recording medium P to the image forming unit 12 and a medium discharge unit 54 that discharges the recording medium P on which the toner images are formed. In addition, the medium transportation device 50 includes a medium return unit 56 and an intermediate transportation unit 58 that are used in a case where images are to be formed on both surfaces of the recording medium P.

The postprocessing unit 60 includes a medium cooling unit 62 that cools the recording medium P to which the toner images are transferred by the image forming unit 12, a correcting device 64 that corrects a bend of the recording medium P, and an image inspection unit 66 that inspects an image formed on the recording medium P. Each part constituting the postprocessing unit 60 is disposed in the medium discharge unit 54 of the medium transportation device 50.

In the case of the image forming system 10, each part except for a discharged medium receiving portion 541 is accommodated in a housing 90. The housing 90 in the present exemplary embodiment has a two-part structure consisting of a first housing 91 and a second housing 92 that are adjacent to each other in the apparatus width direction. Accordingly, the unit of transportation in the image forming system 10 is small in the apparatus width direction.

The first housing 91 accommodates a major part of the image forming unit 12 excluding the fixing device 40 and accommodates the medium supply unit 52. The second housing 92 accommodates the fixing device 40 constituting the image forming unit 12, the medium discharge unit 54, the medium cooling unit 62, the image inspection unit 66, the medium return unit 56, the control unit 70, and the power supply unit 80.

The first housing 91 and the second housing 92 are coupled to each other by means of a coupler such as a bolt and a nut (not shown), for example. Between the first housing 91 and the second housing 92 that are in a state of being coupled to each other in this manner, a communication opening portion 90C1 for the recording medium P that leads to a fixation nip NF from a transfer nip NT of the image forming unit 12 and a communication path 90C2 for the recording medium P that leads to the medium supply unit 52 from the medium return unit 56 are formed.

### Image Forming Unit

Here, the “image forming unit” will be described in detail.

The image forming unit 12 includes the toner image forming units 20, the transfer device 30, and the fixing device 40. In the present exemplary embodiment, toner image forming units 20Y, 20M, 20C, and 20K that respectively form toner images of yellow (Y), magenta (M), cyan (C), and black (K) are provided. The image forming unit 12 forms an image on the recording medium P, which is an example of a medium, by using toners.

The toner image forming units 20Y, 20M, 20C, and 20K are arranged along an upper side portion of a transfer belt 31 in the order of the toner image forming unit 20Y→the toner image forming unit 20M→the toner image forming unit 20C→the toner image forming unit 20K starting from an upstream side in a movement direction of the transfer belt 31. That is, toner images are formed on the transfer belt 31 in the order of a color Y→a color M→a color C→a color K.

The toner image forming units 20Y, 20M, 20C, and 20K are configured in the same manner as each other. In a case where it is not necessary to distinguish the toner image forming units 20Y, 20M, 20C, and 20K by the color thereof, the toner image forming units 20Y, 20M, 20C, and 20K will be collectively referred to as the toner image forming units 20. As shown in FIG. 2, the toner image forming units 20 include image formation units 14 and toner cartridges 27 that hold toners. The image formation units 14 for respective colors will also be described without being distinguished by the color thereof. Each image formation unit 14 includes a photoreceptor drum 21, a charger 22, an exposure device 23, a developing device 24, a cleaning device 25, and a charge erasing device 26. The photoreceptor drum 21 is an example of a photoreceptor.

A photosensitive layer is formed on a surface of the photoreceptor drum 21. The charger 22 charges the surface (the photosensitive layer) of the photoreceptor drum 21 by means of, for example, a corona discharge method or the like. The exposure device 23 irradiates, with exposure light L, the surface of the photoreceptor drum 21 charged by the charger 22 so that an electrostatic latent image is formed on the surface of the photoreceptor drum 21. The exposure light L is modulated in accordance with image data received from an image signal processing unit 71 (refer to FIG. 1) of the control unit 70. The developing device 24 forms a toner image on the surface of the photoreceptor drum 21 by developing the electrostatic latent image formed on the surface of the photoreceptor drum 21 with a developer G containing toner.

The cleaning device 25 has a blade-like shape and scrapes toner remaining on the surface of the photoreceptor drum 21 off the surface of the photoreceptor drum 21 after transfer of the toner image to the transfer device 30. The charge erasing device 26 erases charge by irradiating the photoreceptor drum 21 with light after the transfer. Accordingly, the charging history on the surface of the photoreceptor drum 21 is canceled. The toner cartridges 27 supply toners to the developing devices 24.

The transfer device 30 primarily transfers, to the transfer belt 31, toner images on the photoreceptor drums 21 for respective colors such that the toner images are superimposed on each other and secondarily transfers, to the recording medium P, the superimposed toner images. A specific description will be made below.

The transfer belt 31 has an endless shape as shown in FIG. 2 and is wound around a plurality of rolls 32. A roll 32D functions as a driving roll that revolves the transfer belt 31 in a direction along an arrow A by means of power of a motor (not shown). In addition, a roll 32T functions as a tension applying roll that applies tension to the transfer belt 31. A lower end-side apex portion of the transfer belt 31, at which an obtuse angle is formed, is wound around a roll 32B. The roll 32B functions as a facing roll for a secondary transfer roll 34, which will be described later. The transfer belt 31 comes into contact with the photoreceptor drums 21 for the respective colors from below at the upper side portion extending in the apparatus width direction.

Inside the transfer belt 31, primary transfer rolls 33, which are examples of transfer members that transfer respective toner images of the photoreceptor drums 21 to the transfer belt 31, are disposed. Each of the primary transfer rolls 33 is disposed to face the photoreceptor drum 21 of a corresponding color with the transfer belt 31 interposed therebetween. In addition, a transfer bias voltage having a polarity opposite to a toner polarity is applied to the primary transfer roll 33. As the transfer bias voltage is applied, a toner image formed on the photoreceptor drum 21 is transferred to the transfer belt 31. Note that a density sensor 36 that detects the densities of toner images transferred onto the transfer belt 31 is provided downstream of primary transfer positions of the transfer belt 31.

In addition, the transfer device 30 includes the secondary transfer roll 34 that transfers, to the recording medium P, toner images superimposed on the transfer belt 31. The secondary transfer roll 34 is disposed such that the transfer belt 31 is interposed between the secondary transfer roll 34 and the roll 32B and forms the transfer nip NT that is formed between the secondary transfer roll 34 and the transfer belt 31. The recording medium P is supplied to the transfer nip NT from the medium supply unit 52 at an appropriate time. A transfer bias voltage having a polarity opposite to the toner polarity is applied to the secondary transfer roll 34 by an electricity supply unit (not shown). As the transfer bias voltage is applied, the toner images are transferred from the transfer belt 31 to the recording medium P passing through the transfer nip NT.

Furthermore, the transfer device 30 includes a cleaning device 35 that cleans the transfer belt 31 after secondary transfer. In a revolution direction of the transfer belt 31, the cleaning device 35 is disposed downstream of a portion (the transfer nip NT) at which secondary transfer is performed and is disposed upstream of a portion at which first transfer is performed. The cleaning device 35 includes a blade 351 and scrapes toner remaining on a surface of the transfer belt 31 off the surface of the transfer belt 31.

The fixing device 40 fixes a toner image to the recording medium P to which the toner image is transferred at the transfer device 30. In the present exemplary embodiment, the fixing device 40 fixes the toner image to the recording medium P by heating and pressurizing the toner image at the fixation nip NF that is formed by a fixation belt 411 and a pressurization roll 42, the fixation belt 411 being wound around a plurality of rolls 413.

A roll 413H is a heating roll that includes, for example, a heater provided in the heating roll and that is rotated by a driving force transmitted from a motor (not shown). Accordingly, the fixation belt 411 circulates in a direction along an arrow R. In addition, the pressurization roll 42 is also rotated at the same circumferential speed as the fixation belt 411 by a driving force transmitted from a motor (not shown).

### Medium Transportation Device

Here, the “medium transportation device” will be described in detail.

As shown in FIG. 1, the medium transportation device 50 includes the medium supply unit 52, the medium discharge unit 54, the medium return unit 56, and the intermediate transportation unit 58.

The medium supply unit 52 includes accommodation containers 521 in which the recording mediums P are stacked and accommodated. In the present exemplary embodiment, two accommodation containers 521 are arranged in the apparatus width direction below the transfer device 30. A plurality of transportation roll pairs 522 and the like form a medium supply path 52P leading from each of the accommodation containers 521 to the transfer nip NT, which is a secondary transfer position.

Above each of the accommodation containers 521, a feeding roll 523 that feeds the uppermost recording medium P stacked in the accommodation container 521 is disposed. Of the plurality of transportation roll pairs 522, transportation roll pairs 522S that are closest to an upstream side in a transportation direction of the recording mediums P function as separation rolls that separate the recording mediums P in an one-by-one manner, the recording mediums P being fed by the feeding rolls 523 from the accommodation containers 521 such that the recording mediums P overlap with each other. The recording mediums P fed from the accommodation containers 521 are transported through supply paths 52P1 of the medium supply path 52P. In addition, of the plurality of transportation roll pairs 522, a transportation roll pair 522R that is positioned immediately upstream of the transfer nip NT in the transportation direction of the recording medium P operates such that the timing of movement of toner images on the transfer belt 31 and the timing of transportation of the recording medium P match each other.

In addition, the medium supply unit 52 includes a spare transportation path 52Pr. The spare transportation path 52Pr starts from an opening portion 91W of the first housing 91 that is on a side opposite to a second housing 92 side and joins a fold portion 52P2 of the medium supply path 52P. The spare transportation path 52Pr is a transportation path that is used in a case where the recording medium P fed from an optional recording medium supply device (not shown) disposed adjacent to the opening portion 91W of the first housing 91 is to be fed to the image forming unit 12.

The intermediate transportation unit 58 includes a plurality of belt transportation members 581 that are disposed over an area between the transfer nip NT of the transfer device 30 and the fixation nip NF of the fixing device 40 and that include endless transportation belts wound around rolls. Each of the belt transportation members 581 is configured such that the transportation belt revolves to transport the recording medium P while the recording medium P is being attracted to a surface of the transportation belt due to air being sucked (negative-pressure suction) from inside. Each belt transportation member 581 includes a plurality of rolls 582 that support the transportation belt. A transportation path 58P is formed on the belt transportation members 581.

The medium discharge unit 54 discharges the recording medium P, on which toner images are fixed by the fixing device 40 of the image forming unit 12, to the outside of the housing 90 through a discharge port 92W formed at an end portion of the second housing 92 that is on a side opposite to a first housing 91 side. The medium discharge unit 54 includes the discharged medium receiving portion 541 that receives the recording medium P discharged through the discharge port 92W.

The medium discharge unit 54 includes a medium discharge path 54P for transportation of the recording medium P from the fixing device 40 (the fixation nip NF) to the discharge port 92W. The medium discharge path 54P is formed by a belt transportation member 543, a plurality of roll pairs 542, and the like. In addition, of the plurality of roll pairs 542, a roll pair 542E that is disposed closest to a downstream side in a discharge direction of the recording medium P functions as a discharge roll that discharges the recording medium P to the discharged medium receiving portion 541.

The medium return unit 56 includes a plurality of roll pairs 561. The plurality of roll pairs 561 form an inversion path 56P to which the recording medium P passing through the image inspection unit 66 is fed in a case where there is a request to form images on both surfaces. The inversion path 56P includes a branch path 56P1, a transportation path 56P2, and an inversion path 56P3. The branch path 56P1 branches off from the medium discharge path 54P. Through the transportation path 56P2, the recording medium P received from the branch path 56P1 is fed to the medium supply path 52P. The inversion path 56P3 is provided at an intermediate portion of the transportation path 56P2 and at the inversion path 56P3, the transportation direction of the recording medium P transported through the transportation path 56P2 is reversed (the recording medium P is switchback-transported) so that the recording medium P is inverted upside down.

### Postprocessing Unit

The medium cooling unit 62, the correcting device 64, and the image inspection unit 66 constituting the postprocessing unit 60 are arranged in this order from an upstream side in the discharge direction while being disposed upstream of a portion of the medium discharge path 54P of the medium discharge unit 54, at which the branch path 56P1 branches off, in the discharge direction of the recording medium P.

The medium cooling unit 62 includes a heat absorbing device 621 that absorbs heat of the recording medium P and a pressing device 622 that presses the recording medium P against the heat absorbing device 621. The heat absorbing device 621 is disposed on an upper side with respect to the medium discharge path 54P, and the pressing device 622 is disposed on a lower side with respect to the medium discharge path 54P.

The heat absorbing device 621 includes an endless heat absorption belt 6211, a plurality of rolls 6212 that support the heat absorption belt 6211, a heat sink 6213 that is disposed inside the heat absorption belt 6211, and a fan 6214 that cools the heat sink 6213. An outer peripheral surface of the heat absorption belt 6211 comes into contact with the recording medium P such that heat can be exchanged. Of the plurality of rolls 6212, a roll 6212D functions as a driving roll that transmits a driving force to the heat absorption belt 6211. Over a predetermined area along the medium discharge path 54P, the heat sink 6213 is in surface contact with an inner peripheral surface of the heat absorption belt 6211 to be slidable.

The pressing device 622 includes an endless pressing belt 6221 and a plurality of rolls 6222 that support the pressing belt 6221. The pressing belt 6221 is wound around the plurality of rolls 6222. The pressing device 622 transports the recording medium P together with the heat absorption belt 6211 while pressing the recording medium P against the heat absorption belt 6211 (the heat sink 6213).

The correcting device 64 is provided downstream of the medium cooling unit 62 in the medium discharge unit 54. The correcting device 64 corrects a bend (a curl) of the recording medium P received from the medium cooling unit 62. In addition, an inline sensor 661 constituting a major part of the image inspection unit 66 is disposed downstream of the correcting device 64 in the medium discharge unit 54. The inline sensor 661 detects, based on light emitted to the recording medium P and reflected from the recording medium P, the presence or absence and the degree of a toner density defect, an image defect, an image position defect, or the like of a fixed toner image.

### Configuration of Cyclone Device

Next, an example of the configuration of a cyclone device of the first exemplary embodiment will be described.

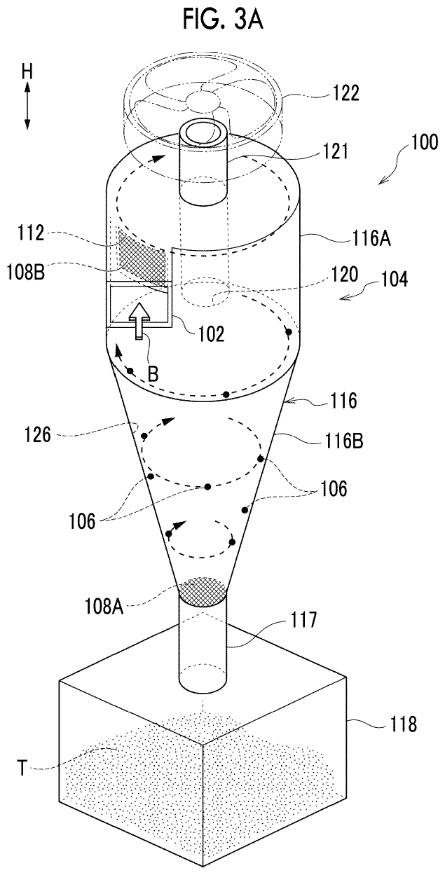

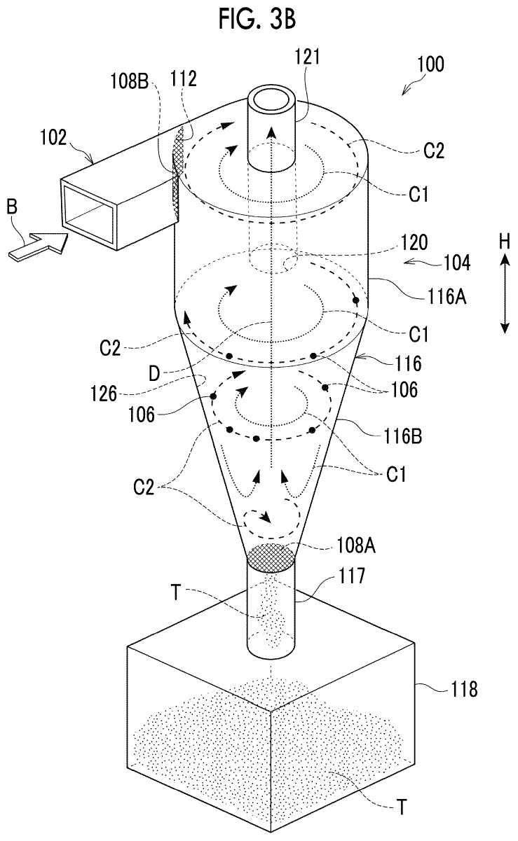

FIG. 3A is a perspective view showing an example of the configuration of a cyclone device 100 and a state during operation. FIG. 3B is a schematic perspective view showing the flow of air and toner in the cyclone device 100. In FIG. 3B, the cyclone device 100 as seen in a direction different from a direction in the case of the cyclone device 100 shown in FIG. 3A is shown.

The image forming system 10 is provided with the cyclone device 100. As shown in FIGS. 3A and 3B, the cyclone device 100 includes an air introduction path 102, a cyclone capturing unit 104, a plurality of cleaning members 106, and a holding member 108A.

### Air Introduction Path

Through the air introduction path 102, air containing toner T in the image forming unit 12 (refer to FIG. 1) in the image forming system 10 is transferred to the cyclone capturing unit 104. Although not shown, an upstream-side end portion of the air introduction path 102 in a direction in which the air flows is connected to an internal portion of the image forming unit 12 in the first housing 91 (refer to FIG. 1). For example, the upstream-side end portion of the air introduction path 102 in the direction in which the air flows is connected to a housing of the developing device 24 (refer to FIG. 1) disposed in the image forming unit 12. Although not shown, the air introduction path 102 may be configured such that four branch paths connected to the developing devices 24 of yellow (Y), magenta (M), cyan (C), and black (K) join one air introduction path 102, for example. For example, the air introduction path 102 is a rectangular tubular portion.

### Cyclone Capturing Unit

As shown in FIGS. 3A and 3B, the cyclone capturing unit 104 includes a suction port 112, a cyclone container 116, a discharge path 117, a collection container 118, and a gas outlet port 120. Furthermore, the cyclone capturing unit 104 includes a gas discharge fan 122 (refer to FIG. 3A). The cyclone container 116 is an example of a container, and the collection container 118 is an example of a collection portion. The gas discharge fan 122 is an example of a sending device.

The suction port 112 is an opening provided at a downstream-side end portion of the air introduction path 102 in the direction in which the air flows. For example, the suction port 112 is provided at a connection portion between the air introduction path 102 and the cyclone container 116. Through the suction port 112, the air containing the toner T in the image forming unit 12 is sucked in a direction along an arrow B. For example, the air containing the toner T in the housing of the developing device 24 is sucked through the suction port 112. The suction port 112 is provided on an upper portion side of the cyclone container 116.

The cyclone container 116 is a tubular container in which air sucked in through the suction port 112 is swirled. The cyclone container 116 includes a cylindrical portion 116A that is disposed at an upper portion in a vertical direction and an inverted conical portion 116B that is disposed at an intermediate portion in the vertical direction. The cylindrical portion 116A and the inverted conical portion 116B are connected to each other in the vertical direction, so that internal spaces thereof are connected to each other.

The cylindrical portion 116A has a cylindrical outer shape as seen in a plan view. The inner diameter of the cylindrical portion 116A is larger than the inner diameter of a portion of the cyclone container 116 other than the cylindrical portion 116A. For example, the inner diameter of the cylindrical portion 116A is uniform in the vertical direction.

The air introduction path 102 is connected to the cylindrical portion 116A. For example, the air introduction path 102 extends in a direction that is tangent to the cylindrical portion 116A. Accordingly, it is possible to cause air to flow into the cylindrical portion 116A from the air introduction path 102 via the suction port 112 in the direction that is tangent to the cylindrical portion 116A.

The inverted conical portion 116B is connected to a lower end portion of the cylindrical portion 116A. The inverted conical portion 116B is provided at a lower portion of the cyclone container 116. The inverted conical portion 116B has an inverted-conical shape of which the inner diameter gradually increases from a lower portion side toward an upper portion side in the vertical direction. In a side view, in the cyclone container 116, the inverted conical portion 116B includes an inclined surface 126 that is inclined to form an angle with respect to a horizontal direction. The inclined surface 126 is an example of an inclination. In the cyclone container 116, an angle θ1 (refer to FIG. 6) of the inclined surface 126 with respect to the horizontal direction is an obtuse angle.

The discharge path 117 is a cylindrical tubular portion and is connected to a lower end portion of the inverted conical portion 116B. For example, the inner diameter of the discharge path 117 is uniform in the vertical direction.

The collection container 118 is provided on a lower portion side of the cyclone container 116. The collection container 118 is connected to a lower end portion of the discharge path 117. The collection container 118 collects toner. For example, the outer shape of the collection container 118 is larger than the outer shape of the discharge path 117. The collection container 118 may be configured to be removable with respect to the discharge path 117 or the cyclone container 116.

A gas discharge pipe 121 is provided at an upper portion of the cyclone container 116. For example, a lower portion of the gas discharge pipe 121 is the gas outlet port 120 that is open in the cylindrical portion 116A of the cyclone container 116. Through the gas outlet port 120, air in the cyclone container 116 is discharged. For example, the gas discharge pipe 121 is disposed along the vertical direction at a central portion in the cylindrical portion 116A. That is, the gas discharge pipe 121 extends in a direction away from an upper surface of the cylindrical portion 116A. In addition, a gas discharge direction of the gas discharge pipe 121 intersects an introduction direction of the air introduction path 102 that is represented by the arrow B. For example, a gas outlet port 120 is provided in a direction intersecting the suction port 112 at the upper portion of the cyclone container 116.

The gas discharge fan 122 is provided at an upper end portion of the gas discharge pipe 121. The upper end portion of the gas discharge pipe 121 is a downstream-side end portion in a direction in which air flows due to the gas discharge fan 122. The gas discharge fan 122 rotates such that air is sucked into the cyclone container 116 through the suction port 112 and causes the air to swirl in the cyclone container 116 such that an air stream to be discharged through the gas outlet port 120 is generated. For example, the gas discharge fan 122 discharges air in the cyclone container 116 upward.

An air blowing rate of the gas discharge fan 122 can be changed in a stepwise or stepless manner by changing the speed of rotation. In addition, the air blowing rate of the gas discharge fan 122 at the time of cleaning of the cyclone capturing unit 104 is different from the air blowing rate at the time of image formation performed by the image forming unit 12.

In addition, the gas discharge fan 122 intermittently changes the air blowing rate at the time of the cleaning of the cyclone capturing unit 104. Here, “intermittently change” means to continuously change with occasional discontinuities. For example, the air blowing rate is intermittently changed a predetermined number of times in a unit time (for example, 1 minute). For example, it is preferable that the gas discharge fan 122 changes the air blowing rate from a high air blowing rate to a low air blowing rate. The operation of the gas discharge fan 122 is controlled by the control unit 70. The operation of the gas discharge fan 122 will be described later.

As shown in FIG. 3A, in the cyclone capturing unit 104, the gas discharge fan 122 is rotated such that air is sucked into the cyclone container 116 through the suction port 112. Then, the air and the toner T are swirled in the cyclone container 116 such that the toner T is separated from the air due to a centrifugal force. For example, as shown in FIG. 3B, the air swirls in the inverted conical portion 116B of the cyclone container 116 as represented by an arrow C1 having a small radius, and the toner T swirls as represented by an arrow C2 having a large radius. Accordingly, the toner T is separated from the air, and the toner Tis captured and collected into the collection container 118. In the cyclone capturing unit 104 of the first exemplary embodiment, the toner T settles due to gravity and is collected into the collection container 118 below the cyclone container 116. As represented by an arrow D, the air from which the toner T has been separated is discharged through the gas outlet port 120 provided at an upper portion.

### Plurality of Cleaning Members

As shown in FIGS. 3A and 3B, the cleaning members 106 are granular. For example, the cleaning members 106 are spherical. The plurality of cleaning members 106 are accommodated in the cyclone container 116 and can be swirled together with air. For example, the particle diameter of the cleaning member 106 is larger than the particle diameter of the toner T.

The plurality of cleaning members 106 contain a material that is less likely to be charged or a material that is charged with the same polarity as the toner T. Accordingly, the toner T is less likely to adhere to the plurality of cleaning members 106.

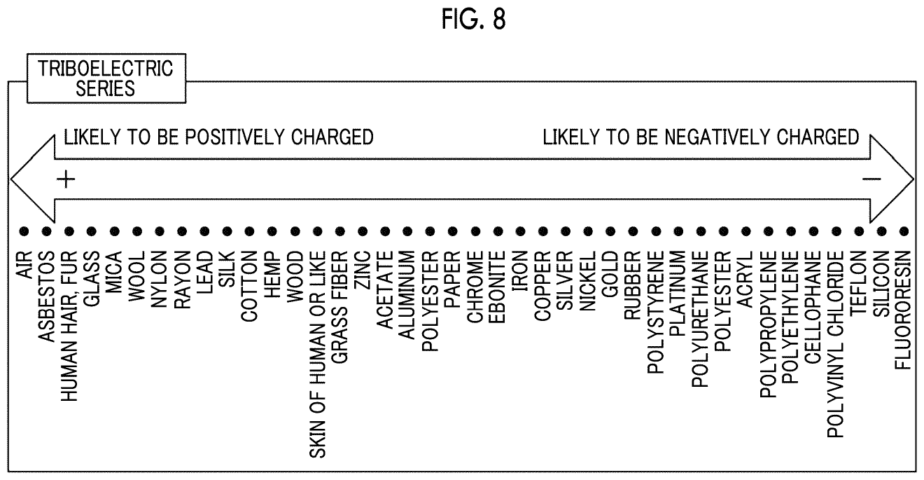

FIG. 8 is a diagram showing a triboelectric series of materials. The triboelectric series is a rank in which the respective likelihoods of being positively (+) charged or negatively (−) charged of the materials of substances are arranged in order and the triboelectric series serves as a standard for determination on whether a material is being positively charged or negatively charged depending on a substance that comes into contact with the material. For example, in a case where the toner T is negatively charged, it is preferable that a material that is negatively charged with the same polarity as the toner T. As shown in FIG. 8, it is preferable to use, for example, iron, copper, aluminum, resins (for example, polyethylene, polypropylene, or the like) to the right of polystyrene, or the like as the material that is negatively charged with the same polarity as the toner T.

The “material that is less likely to be charged” means a material that constitutes the cyclone container 116 or a material close as the triboelectric series (a material that results in the cleaning member 106 being likely to be charged with the same polarity as the toner with respect to the material of the cyclone container 116).

Examples of the same material as the material of the cyclone container 116 are as follows. For example, in a case where the cyclone container 116 is made of stainless steel (SUS), it is preferable that the cleaning member 106 contains stainless steel (SUS). For example, in a case where the cyclone container 116 is made of an ABS resin (a thermoplastic resin composed of three kinds of monomers that are acrylonitrile, butadiene, and styrene), it is preferable that the cleaning member 106 contains an ABS resin.

Examples of a material different from the material of the cyclone container 116 are as follows. For example, in a case where the cyclone container 116 is made of stainless steel (SUS), it is preferable that the cleaning member 106 contains steel or rubber (in a case where the toner is negatively charged).

For example, the plurality of cleaning members 106 are composed of cleaning members of one type that are the same as each other in density and material.

As shown in FIG. 3A, in the cyclone device 100, an inner wall of the cyclone container 116 can be cleaned with the plurality of cleaning members 106 swirling in the cyclone container 116 in a case where the gas discharge fan 122 is driven. A cleaning function realized by the plurality of cleaning members 106 will be described later.

### Holding Member

As shown in FIG. 3A, the holding member 108A is provided at at least a lower end portion of the inclined surface 126 in the cyclone container 116, and holds the plurality of cleaning members 106 inside the cyclone container 116. For example, the holding member 108A is attached to a wall of a connection portion between the inverted conical portion 116B and the discharge path 117.

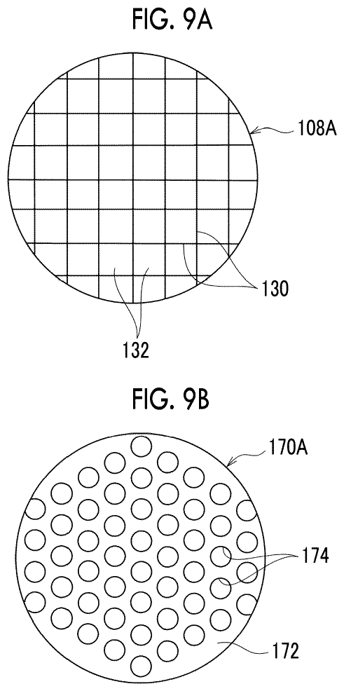

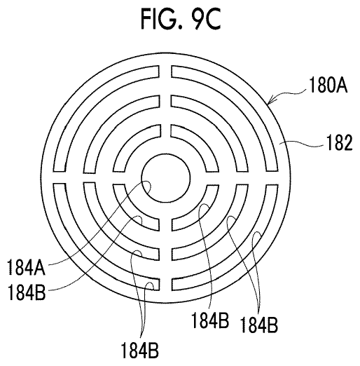

FIG. 9A is a plan view showing the holding member 108A of a first example. As shown in FIG. 9A, the holding member 108A is composed of a mesh-shaped member 130. A mesh shape means a net or lattice-like structure. For example, the mesh-shaped member 130 is obtained by knitting a linear member into a mesh shape. As described above, the particle diameter of the cleaning members 106 is larger than the particle diameter of the toner T. The holding member 108A includes a plurality of holes 132 (that is, the plurality of holes 132 in the mesh-shaped member 130) that are larger than the particle diameter of the toner T and smaller than the particle diameter of the cleaning members 106. The holding member 108A is an example of a partition member. Since the holding member 108A includes the plurality of holes 132, the holding member 108A allows air and the toner T to pass through the holding member 108A and does not allow the cleaning members 106 to pass through the holding member 108A.

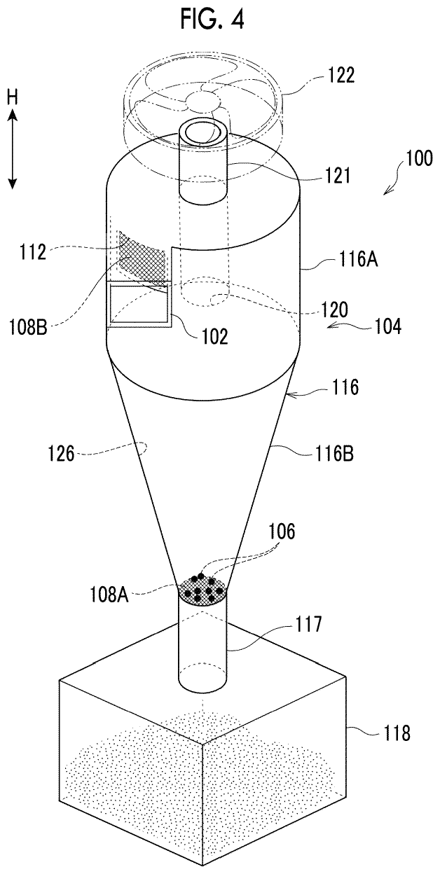

FIG. 4 is a perspective view showing a state where the gas discharge fan 122 in the cyclone device 100 is stopped. As shown in FIG. 4, in a case where the gas discharge fan 122 is stopped, the plurality of cleaning members 106 fall to the lower portion of the cyclone container 116 due to gravity and accumulate on the holding member 108A. The holding member 108A allows air and the toner T to pass through the holding member 108A and does not allow the cleaning members 106 to pass through the holding member 108A. Therefore, the plurality of cleaning members 106 are held in the cyclone container 116. Regarding the number of the plurality of cleaning members 106, for example, it is preferable that the entire surface of the holding member 108A is not covered (that is, the holding member 108A is partially exposed) in a state where the gas discharge fan 122 is stopped. Accordingly, air can pass through the holding member 108A with the plurality of cleaning members 106 accumulating on the holding member 108A. Therefore, the function of the cyclone capturing unit 104 can be maintained.

In the cyclone device 100, an upper side of the cyclone container 116 is also provided with a holding member 108B. For example, the holding member 108B is attached to a wall around the suction port 112 of the air introduction path 102. The holding member 108B is composed of the mesh-shaped member 130 as with the holding member 108A. The holding member 108B restrain the plurality of cleaning members 106 from leaking to the air introduction path 102 from the cyclone container 116.

FIG. 9B is a plan view showing a holding member 170A of a second example. The holding member 170A may be provided at at least the lower end portion of the inclined surface 126 in the cyclone container 116 instead of the holding member 108A shown in FIG. 9A. As shown in FIG. 9B, a large number of holes 174 are formed in a plate-shaped body 172 of the holding member 170A. The holding member 170A is an example of a partition member. The holes 174 are larger than the particle diameter of the toner T and are smaller than the particle diameter of the cleaning members 106. For example, the outer shape of a region in which the plurality of holes 174 are disposed is a hexagonal shape. However, the way in which the plurality of holes 174 are disposed can be changed.

Although not shown, in the cyclone device 100, a holding member having the same configuration as the holding member 170A may also be provided on the upper side of the cyclone container 116 instead of the holding member 108B shown in FIG. 9A.

FIG. 9C is a plan view showing a holding member 180A of a third example. The holding member 180A may be provided at at least the lower end portion of the inclined surface 126 in the cyclone container 116 instead of the holding member 108A shown in FIG. 9A. Regarding the holding member 180A, a circular hole 184A is formed at a center portion of a plate-shaped body 182, and a plurality of curved holes 184B disposed to be concentric with each other are formed around the hole 184A as shown in FIG. 9C. The holding member 180A is an example of a partition member. The holes 184A and 184B are larger than the particle diameter of the toner T and have sizes enough to prevent the cleaning member 106 from passing through the holes 184A and 184B.

Although not shown, in the cyclone device 100, a holding member having the same configuration as the holding member 180A may also be provided on the upper side of the cyclone container 116 instead of the holding member 108B shown in FIG. 9A. Regarding the holding member, the number of holes 184B can be changed. In addition, a holding member obtained by cutting a sheet-shaped member larger than the holding member 180A to match the shape of the suction port 112 may also be used.

### Hardware Configuration of Image Forming System

Next, a hardware configuration of the image forming system 10 will be described.

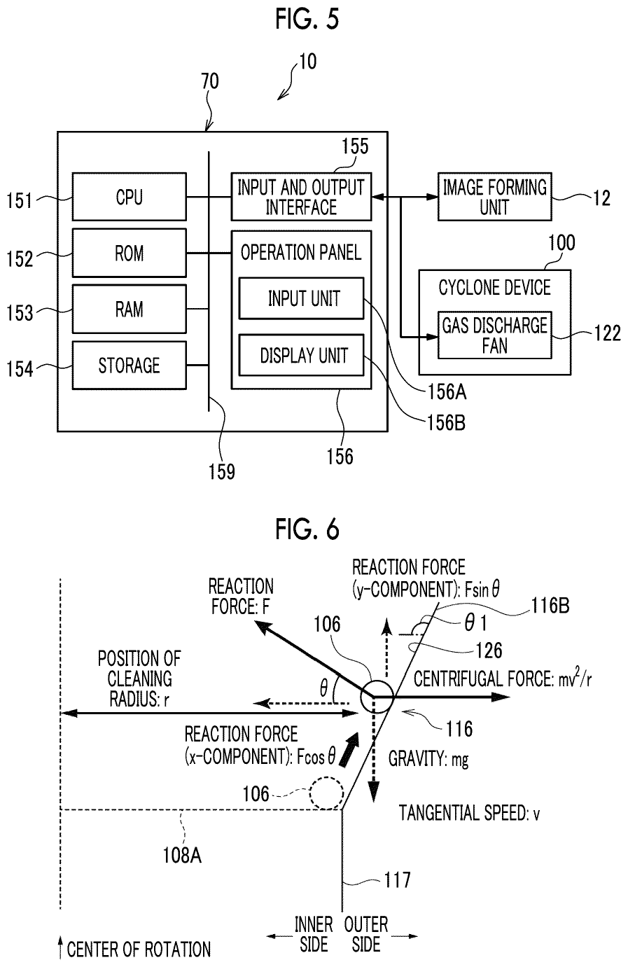

FIG. 5 is a block diagram showing the hardware configuration of the image forming system 10. Only a configuration related to the present disclosure is shown in FIG. 5 and a configuration not related to the present disclosure is not shown.

As shown in FIG. 5, the image forming system 10 includes the control unit 70 and the cyclone device 100. The control unit 70 includes a central processing unit (CPU) 151, a read only memory (ROM) 152, a random access memory (RAM) 153, a storage 154, an input and output interface 155, and an operation panel 156 as components thereof. The components are connected to each other via a bus 159 such that the components can communicate with each other.

The CPU 151 is a central processing unit and executes various programs or controls each unit. The CPU 151 is an example of a processor. That is, the CPU 151 reads out a program from the ROM 152 or the storage 154, and executes the program by using the RAM 153 as a working area. The CPU 151 controls each of the above-described components and performs various types of arithmetic processes according to the program recorded on the ROM 152 or the storage 154. In the first exemplary embodiment, the ROM 152 or the storage 154 stores a driving program of the cyclone device 100.

The ROM 152 stores various programs and various types of data. The RAM 153 temporarily stores programs or data as a work area. The storage 154 is composed of a hard disk drive (HDD) or a solid state drive (SSD) and stores various programs including an operating system and various types of data. For example, a program of a printer driver is stored in the ROM 152 or the storage 154. The CPU 151 reads out the program of the printer driver from the ROM 152 or the storage 154 and executes the program to function as the printer driver.

The input and output interface 155 is an interface for transmission and reception of information and the like to and from each of the components mounted in the image forming system 10. For example, the input and output interface 155 is electrically connected to each part of the image forming unit 12 and the gas discharge fan 122 in the cyclone device 100. Accordingly, the CPU 151 controls, based on the program of the printer driver stored in the ROM 152 or the storage 154, an image forming operation performed by the image forming unit 12. In addition, the CPU 151 controls, based on the driving program of the cyclone device 100 stored in the ROM 152 or the storage 154, the operation of the gas discharge fan 122.

The operation panel 156 includes an input unit 156A and a display unit 156B. Through the input unit 156A, various input operations such as issuing an instruction to perform printing are performed. The display unit 156B is, for example, a liquid crystal display and displays various types of information. A touch panel type display unit is adopted as the display unit 156B and a part of the display unit 156B functions as the input unit 156A. Note that the operation panel 156 may be configured to be electrically connected via the input and output interface 155.

The CPU 151 controls the operation of the gas discharge fan 122 to change an air blowing rate at the time of image formation performed by the image forming unit 12 and an air blowing rate at the time of cleaning of the cyclone capturing unit 104. For example, the CPU 151 controls the operation of the gas discharge fan 122 to make the air blowing rate at the time of cleaning of the cyclone capturing unit 104 higher than the air blowing rate at the time of image formation performed by the image forming unit 12. The CPU 151 may control the operation of the gas discharge fan 122 to change an air blowing rate before and after an image forming operation performed by the image forming unit 12.

The CPU 151 controls the operation of the gas discharge fan 122 to intermittently change the air blowing rate at the time of the cleaning of the cyclone capturing unit 104. For example, the CPU 151 may control the operation of the gas discharge fan 122 to make a change from a high air blowing rate to a low air blowing rate.

In the image forming system 10, in a case where accumulation of the toner in the cyclone container 116 has progressed, the CPU 151 transitions to a cleaning mode, in which the inside of the cyclone container 116 is cleaned, under a determined condition. For example, the CPU 151 performs cleaning of a wall surface of the cyclone capturing unit 104 in accordance with the amount of image formation performed by the image forming unit 12. Here, the amount of image formation performed by the image forming unit 12 is, for example, an amount corresponding to the total amount of toner consumption in an image forming operation. For example, the total amount of toner consumption is the total toner volume or a value obtained by integrating the total toner volume and the average area coverage.

### Image Forming System of Comparative Example

Here, an image forming system of a comparative example will be described.

For example, an image forming system generally has a configuration in which cloud is captured by means of a non-woven fabric filter, a cyclone, or suction airflow for suppression of contamination in a housing and an image defect caused by toner (cloud) scattered from a developing device.

For example, in a model in which image formation is performed at high speed, the amount of generation of cloud increases with the improvement of productivity. Since the number of times of filter replacement increases in the case of a non-woven fabric filter type, it is conceivable to adopt a cyclone type as a countermeasure.

Although not shown, the image forming system of the comparative example includes a cyclone device into which air containing toner scattered from a developing device is introduced. In the cyclone device, the toner is separated from the air by a centrifugal force caused by a swirling stream of the air in a cyclone container, the toner is collected into a collection container on a lower side, and the air separated from the toner is discharged from an upper side. Note that in the image forming system of the comparative example, a plurality of cleaning members as in the first exemplary embodiment are not accommodated in the cyclone container.

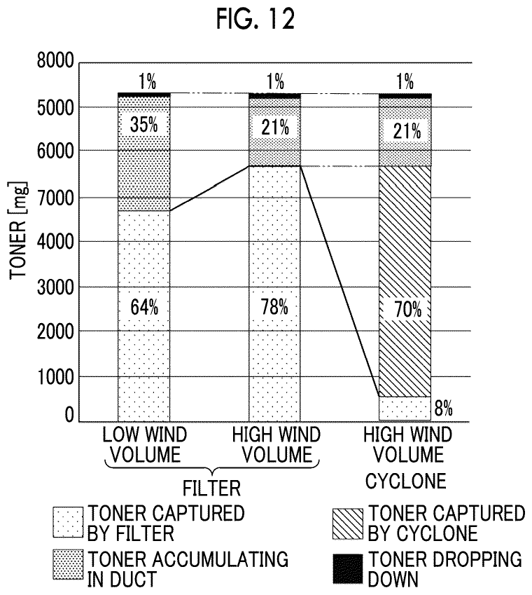

FIG. 12 is a graph for comparison between the amounts of toner captured by a filter and a cyclone. As shown in FIG. 12, in the case of the filter, for improvement in amount of a captured toner, a high wind volume is required. However, a high wind volume results in an increase in number of times of filter replacement. In the case of the cyclone, a high wind volume results in a decrease in amount of toner collected by being captured by the cyclone and amount of toner accumulating in a duct.

As described above, in the image forming system of the comparative example, a high air speed (that is, a high wind volume) is required to reduce the amount of accumulation of the toner on an inner wall of the cyclone container. However, in such a case, a high-output gas discharge fan such as a large-sized AC blower is required and it is difficult to mount a high-output gas discharge fan from the viewpoint of power, noise, and cost in addition to the securing of a space. Meanwhile, in the case of a low-wind-speed gas discharge fan, the toner is likely to adhere to the inner wall of the cyclone container, and thus the degree of pressure loss increases as the toner accumulates, which causes a decrease in wind speed.

For example, a method of unitizing cyclones and periodically replacing the cyclones is also conceivable. However, there is a risk that toner may contaminate the inside of the image forming system in a case where a unit is attached to and detached from the image forming system.

### Cleaning Function Realized by Plurality of Cleaning Members

Next, a cleaning function realized by the plurality of cleaning members 106 will be described.

In the image forming system 10 of the first exemplary embodiment, the plurality of cleaning members 106 are accommodated in the cyclone container 116 and the plurality of cleaning members 106 are caused to swirl by an air stream in the cyclone container 116 so that the inner wall of the cyclone container 116 is cleaned. More specifically, as shown in FIGS. 3A and 3B, the plurality of cleaning members 106 can scrape off an accumulated toner by being swirled along the inner wall of the cyclone container 116, the plurality of cleaning members 106 being swirled by a rotary air stream (that is, a swirling stream) in the cyclone container 116. Accordingly, it is possible to suppress adhesion of toner to the inner wall of the cyclone container 116 without attaching and detaching and replacing the cyclone container 116 provided in the image forming system 10.

The holding member 108A is provided at the lower end portion of the inverted conical portion 116B of the cyclone container 116, and the holding member 108B is provided at the suction port 112 at the upper portion of the cyclone container 116. Each of the holding members 108A and 108B is composed of the mesh-shaped member 130 through which the toner T can pass and through which the cleaning members 106 cannot pass. Therefore, the plurality of cleaning members 106 are held in the cyclone container 116 by the holding members 108A and 108B.

The holding member 108A is provided at the lower end portion of the inverted conical portion 116B. However, the holding member 108A may be disposed above the lower end portion of the inverted conical portion 116B instead of being provided at the lower end portion.

Furthermore, in the cleaning mode of the cyclone container 116, an air blowing rate is changed with the rotation speed of the gas discharge fan 122 so that the position of cleaning performed by the cleaning members 106 (that is, a position at which the cleaning members 106 are held) is changed in a height direction of the cyclone container 116.

FIG. 6 is a view for description of a relationship between forces acting on the cleaning member 106 in the cyclone container 116. As shown in FIG. 6, in a case where the particle diameter of the cleaning member 106 is large (that is, a centrifugal force is larger than a transportation force attributable to a swirling stream), the cleaning member 106 rises, to a position at which the gravity and a reaction force are balanced, along the inclined surface 126 while swirling.

Note that in a case where the cleaning member 106 is disposed below the lower end portion of the inverted conical portion 116B, the cleaning member 106 cannot rise since no y-component reaction force is generated. In the first exemplary embodiment, the holding member 108A is provided at the lower end portion of the inverted conical portion 116B, and thus the cleaning member 106 can rise along the inclined surface 126 of the inverted conical portion 116B.

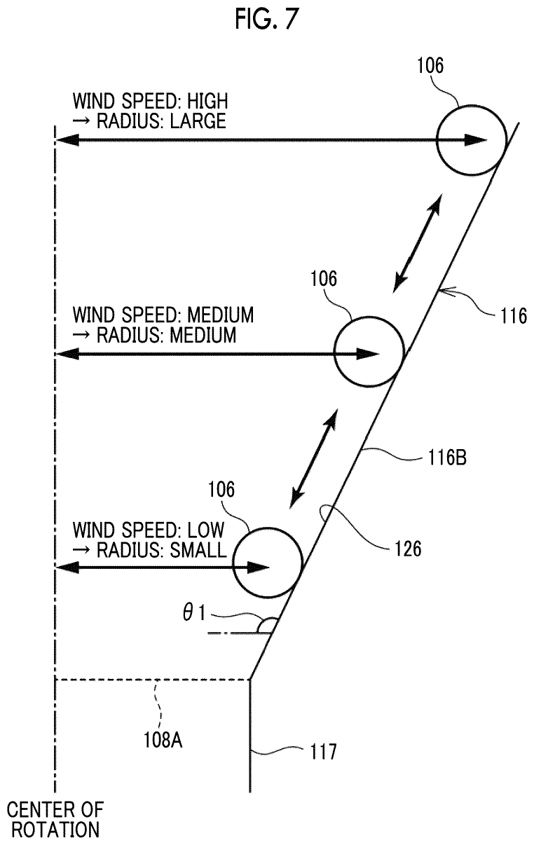

FIG. 7 is a view for description of a relationship between a wind speed in the cyclone container 116 and the position of the cleaning member 106.

A radius r (that is, a rotation radius), which corresponds to the position of cleaning performed by the cleaning member 106, is represented by the following equation from the relationship of balance. Here, as shown in FIG. 6, V is a tangential speed, θ is the angle of a reaction force with respect to the horizontal direction, and g is a gravitational acceleration.

$$r = \frac{{V}^{2}}{g} \times tan θ \qquad Equation 1$$

As understood from the equation in Equation 1, the higher the speed of the cleaning member 106 is, the larger the radius r (that is, the radius of rotation), which corresponds to the position of cleaning performed by the cleaning member 106, is. Therefore, it is possible to change the position of cleaning performed by the cleaning member 106 by changing a wind speed with the gas discharge fan 122.

### Actions and Effects

Next, actions of the first exemplary embodiment will be described.

The image forming system 10 of the first exemplary embodiment includes the image forming unit 12, the cyclone capturing unit 104, the plurality of cleaning members 106, and the holding member 108A. The cyclone capturing unit 104 includes the suction port 112, the cyclone container 116, the collection container 118, and the gas outlet port 120. Through the suction port 112, air containing the toner T in the image forming unit 12 is sucked. The cyclone container 116 is a tubular container in which the air sucked through the suction port 112 is swirled and of which at least a lower portion is provided with the inclined surface 126 at which the inner diameter of the cyclone container 116 gradually increases from a lower portion side toward an upper portion side. The collection container 118 collects the toner. Through the gas outlet port 120, the air is discharged.

In the cyclone capturing unit 104, the air is swirled in the cyclone container 116 such that the toner is separated from the air due to a centrifugal force, the toner is captured and collected into the collection container 118, and the air is discharged through the gas outlet port 120.

For example, as shown in FIGS. 3A and 3B, the gas discharge fan 122 is rotated such that the air containing the toner T in the image forming unit 12 is introduced into the cyclone container 116 via the suction port 112. Furthermore, the toner T is separated from the air by a centrifugal force caused by a swirling stream of the air in the cyclone container 116. Accordingly, the toner T is captured and collected into the collection container 118 and the air separated from the toner Tis discharged through the gas outlet port 120.

The plurality of cleaning members 106 are accommodated in the cyclone container 116. In the cyclone container 116, the plurality of cleaning members 106 swirl together with the air. Accordingly, the toner T is made less likely to adhere to the inner wall of the cyclone container 116 by the plurality of cleaning members 106, and the toner T adhering to the inner wall of the cyclone container 116 can be scraped off by the plurality of cleaning members 106.

Furthermore, the holding member 108A is provided at at least the lower end portion of the inclined surface 126 of the cyclone container 116. The holding member 108A holds the plurality of cleaning members 106 in the cyclone container 116.

Therefore, in the image forming system 10, adhesion of the toner onto a wall surface of the cyclone capturing unit 104 (for example, the cyclone container 116) may be suppressed in comparison with a case where only air containing toner is caused to swirl in the cyclone capturing unit.

In addition, in the image forming system 10, the cyclone capturing unit 104 includes the gas discharge fan 122 that causes the air sucked into the cyclone container 116 to swirl such that an air stream to be discharged through the gas outlet port 120 is generated. Therefore, in the image forming system 10, the air sucked into the cyclone container 116 may be caused by the gas discharge fan 122 to swirl such that an air stream to be discharged through the gas outlet port 120 is generated.

In addition, in the cyclone capturing unit 104, the suction port 112 is provided on an upper portion side of the cyclone container 116 and the collection container 118 is connected to a lower portion side of the cyclone container 116. Furthermore, the gas outlet port 120 is provided in a direction intersecting the suction port 112 at the upper portion of the cyclone container 116.

Accordingly, the toner T is separated from the air by a centrifugal force caused by a swirling stream of the air sucked into the cyclone container 116 through the suction port 112. Then, the toner T settles due to gravity and is collected into the collection container 118 on the lower portion side of the cyclone container 116 and the air from which the toner T has been separated is discharged through the gas outlet port 120 provided on the upper portion side of the cyclone container 116. Therefore, in the image forming system 10, adhesion of the toner onto a wall surface of the cyclone capturing unit 104 (for example, the cyclone container 116) may be suppressed in comparison with a case where a gas inlet port and a gas outlet port face the same side.

In addition, in the image forming system 10, the plurality of cleaning members 106 contain a material that is less likely to be charged or a material that is charged with the same polarity as the toner. Therefore, in the image forming system 10, adhesion of the toner to the cleaning member 106 is suppressed in comparison with a case where the plurality of cleaning members are charged with a polarity opposite to the toner.

In addition, in the image forming system 10, an upper side of the cyclone container 116 is also provided with the holding member 108B. Therefore, in the image forming system 10, the plurality of cleaning members 106 may be held in the cyclone container 116 unlike a case where the upper side of the cyclone container is provided with only an opening.

In addition, in the image forming system 10, the holding members 108A and 108B are partition members including the holes 132 that are larger than the particle diameter of the toner T and smaller than the particle diameter of the cleaning members 106. Therefore, in the image forming system 10, passage of the cleaning members 106 may be prevented while passage of the toner T is allowed since the holes 132 of the holding members 108A and 108B are provided.

In addition, in the image forming system 10, an air blowing rate of the gas discharge fan 122 is changeable in a stepwise or stepless manner. The gas discharge fan 122 changes the air blowing rate in a stepwise or stepless manner so that the position of cleaning performed by the plurality of cleaning members 106 with respect to the inclined surface 126 of the inverted conical portion 116B of the cyclone container 116 is changed. Therefore, in the image forming system 10, the range of cleaning of the wall surface of the cyclone capturing unit 104 (for example, the cyclone container 116) that is performed by the plurality of cleaning members 106 may be expanded in comparison with the case of a constant air blowing rate.

In addition, in the image forming system 10, the air blowing rate of the gas discharge fan 122 at the time of cleaning of the cyclone capturing unit 104 is different from the air blowing rate at the time of image formation performed by the image forming unit 12. Therefore, in the image forming system 10, the region of cleaning of the wall surface of the cyclone capturing unit 104 (for example, the cyclone container 116) that is performed by the plurality of cleaning members 106 may be changed at the time of image formation and at the time of cleaning unlike a case where the air blowing rate is constant at the time of image formation and at the time of cleaning.

In addition, in the image forming system 10, the gas discharge fan 122 intermittently changes the air blowing rate at the time of cleaning. Therefore, in the image forming system 10, it is easy to control the air blowing rate in comparison with a case where the air blowing rate is continuously changed.

In addition, in the image forming system 10, the gas discharge fan 122 changes the air blowing rate before and after an image forming operation performed by the image forming unit 12. Therefore, in the image forming system 10, cleaning of the wall surface of the cyclone capturing unit 104 (for example, the cyclone container 116) that is performed by the plurality of cleaning members 106 may be efficiently performed in comparison with a case where the air blowing rate is not changed before and after the image forming operation.

In addition, in the image forming system 10, the gas discharge fan 122 changes the air blowing rate from a high air blowing rate to a low air blowing rate. Accordingly, in the cyclone container 116, the plurality of cleaning members 106 move from a high position of cleaning to a low position of cleaning and thus the cleaning is performed from the upper portion side to the lower portion side of the cyclone container 116. Therefore, in the image forming system 10, cleaning of the wall surface of the cyclone capturing unit 104 (for example, the cyclone container 116) that is performed by the plurality of cleaning members 106 may be efficiently performed in comparison with a case where the air blowing rate is changed from a low air blowing rate to a high air blowing rate.

In the image forming system 10, the CPU 151 performs cleaning of the wall surface of the cyclone capturing unit in accordance with the amount of image formation performed by the image forming unit 12. Therefore, in the image forming system 10, cleaning of the wall surface of the cyclone capturing unit 104 (for example, the cyclone container 116) that is performed by the plurality of cleaning members 106 may be efficiently performed in comparison with a case where cleaning is performed at certain intervals without consideration of the amount of image formation performed by the image forming unit.

### Second Exemplary Embodiment

Next, an image forming system according to a second exemplary embodiment will be described. Note that, the same components as in the first exemplary embodiment described above are given the same reference numerals and description thereof will be omitted.

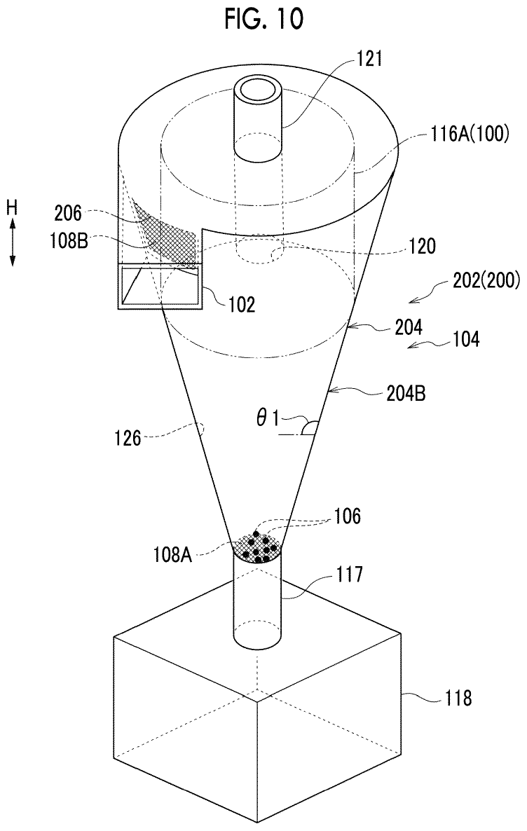

FIG. 10 is a perspective view showing an example of a cyclone device 202 used in an image forming system 200 of the second exemplary embodiment. As shown in FIG. 10, in the image forming system 200 of the second exemplary embodiment, the cyclone device 100 in the image forming system 10 of the first exemplary embodiment is changed to the cyclone device 202.

The cyclone device 202 is provided with the cyclone capturing unit 104 including a cyclone container 204. The cyclone container 204 includes an inverted conical portion 204B of which the inner diameter gradually increases from a lower portion side toward an upper portion side. In the second exemplary embodiment, the inclined surface 126 is also formed at the upper portion of the cyclone container 204 to be seamlessly connected to the inclined surface 126 of a lower portion of the cyclone container 204. The inclined surface 126 is an example of an inclination. In addition, a suction port 206 is formed at a connection portion between the air introduction path 102 and the inverted conical portion 204B. In the vertical direction in the cyclone container 204, the angle θ1 of the inclined surface 126 with respect to the horizontal direction is uniform. Note that other configurations of the image forming system 200 of the second exemplary embodiment are the same as the configurations of the image forming system 10 of the first exemplary embodiment.

In the image forming system 200 of the second exemplary embodiment, in addition to the actions and effects of the same configuration as the image forming system 10 of the first exemplary embodiment, the following actions and effects can be obtained.

In the image forming system 200, the inclined surface 126 is also formed at the upper portion of the cyclone container 204 to be seamlessly connected to the inclined surface 126 of the lower portion of the cyclone container 204. Therefore, in the image forming system 200, the range of cleaning of the wall surface of the cyclone capturing unit 104 (for example, the cyclone container 204) that is performed by the plurality of cleaning members 106 may be expanded in comparison with a case where only the lower portion of the cyclone container is provided with an inclination.

### Third Exemplary Embodiment

Next, an image forming system according to a third exemplary embodiment will be described. Note that, the same components as in the first and second exemplary embodiments described above are given the same reference numerals and description thereof will be omitted.

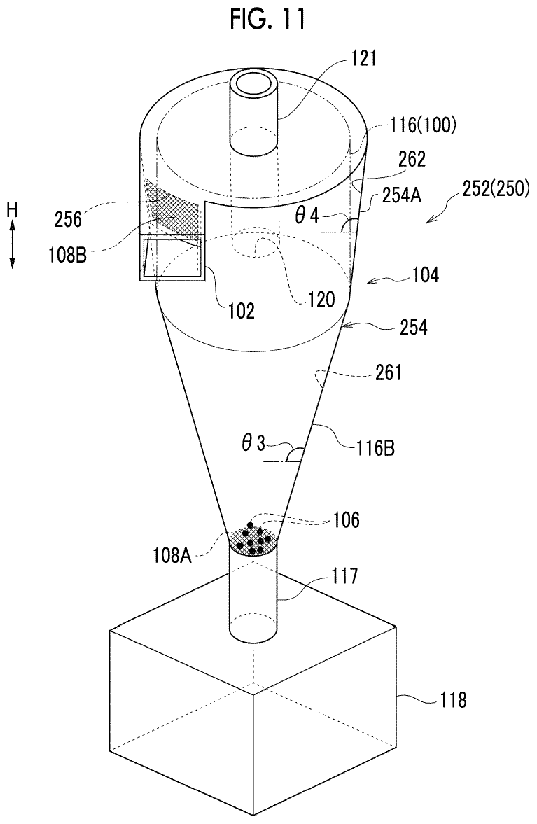

FIG. 11 is a perspective view showing an example of a cyclone device 252 used in an image forming system 250 of the third exemplary embodiment. As shown in FIG. 11, in the image forming system 250 of the third exemplary embodiment, the cyclone device 100 in the image forming system 10 of the first exemplary embodiment is changed to the cyclone device 252.

The cyclone device 252 is provided with the cyclone capturing unit 104 including a cyclone container 254. The cyclone container 254 includes the inverted conical portion 116B on a lower portion side in the vertical direction and an inverted conical tubular portion 254A on an upper portion side in the vertical direction. The inverted conical portion 116B includes a first inclined surface 261 at which the inner diameter of the inverted conical portion 116B gradually increases from the lower portion side toward the upper portion side. The first inclined surface 261 is provided at a position including a lower portion of the cyclone container 254. The first inclined surface 261 is an example of a first inclination.

The inverted conical tubular portion 254A includes a second inclined surface 262 at which the inner diameter of the tubular portion 254A gradually increases from the lower portion side to the upper portion side. The second inclined surface 262 is provided at the upper portion of the cyclone container 254 to be adjacent to the first inclined surface 261. An angle at which the second inclined surface 262 is inclined with respect to the horizontal direction is larger than an angle at which the first inclined surface 261 is inclined with respect to the horizontal direction. That is, the angle at which the second inclined surface 262 is inclined with respect to the horizontal direction is steeper than the angle at which the first inclined surface 261 is inclined with respect to the horizontal direction. In other words, an angle θ4 formed by the second inclined surface 262 and the horizontal direction in the cyclone container 254 is smaller than an angle θ3 formed by the first inclined surface 261 and the horizontal direction in the cyclone container 254. The second inclined surface 262 is an example of a second inclination. In addition, a suction port 256 is formed at a connection portion between the air introduction path 102 and the tubular portion 254A. Note that other configurations of the image forming system 250 of the third exemplary embodiment are the same as the configurations of the image forming system 10 of the first exemplary embodiment.

In the image forming system 250 of the third exemplary embodiment, in addition to the actions and effects of the same configuration as the image forming system 10 of the first exemplary embodiment, the following actions and effects can be obtained.

The image forming system 250 includes the first inclined surface 261 that is provided at a position including the lower portion of the cyclone container 254 and the second inclined surface 262 that is provided at the upper portion of the cyclone container 254 to be adjacent to the first inclined surface 261. The angle at which the second inclined surface 262 is inclined with respect to the horizontal direction is larger than the angle at which the first inclined surface 261 is inclined with respect to the horizontal direction. Therefore, in the image forming system 250, the efficiency of separation in the cyclone capturing unit 104 (for example, the cyclone container 254) may be maintained in comparison with a case where the angle of inclination with respect to the horizontal direction is uniform over the entire vertical region in the cyclone container.

### Modification Examples

In the image forming systems of the first to third exemplary embodiments, the plurality of cleaning members 106 are composed of cleaning members of one type. However, the present disclosure is not limited to such a configuration. For example, in an image forming system of a first modification example, the plurality of cleaning members 106 may include two or more types of cleaning members that are different from each other in at least one of dimension, density, or material. Since the two or more types of cleaning members are included, the position of cleaning performed by the different types of cleaning members is changed in the case of a constant wind speed. Therefore, in the image forming system of the first modification example, cleaning of the wall surface of the cyclone capturing unit 104 (for example, the cyclone container) that is performed by the plurality of cleaning members 106 in the case of a constant wind speed may be performed over a wide area in comparison with a case where the plurality of cleaning members include cleaning members of only one type.

In addition, in the image forming systems of the first to third exemplary embodiments, the gas discharge fan 122 intermittently changes the air blowing rate. However, the present disclosure is not limited to such a configuration. For example, in an image forming system of a second modification example, the gas discharge fan 122 may periodically change the air blowing rate. Here, “periodically change” means to repeat blowing air and stopping blowing air. For example, the gas discharge fan 122 is driven for a determined first time, and the gas discharge fan 122 is stopped for a determined second time. Thereafter, within the determined first time, the air blowing rate is changed with the gas discharge fan 122 being driven. The air blowing rate may be changed when operation is repeated periodically in this manner. Therefore, in the image forming system of the second modification example, it is easy to control the air blowing rate in comparison with a case where the air blowing rate is continuously changed.

Note that, although specific exemplary embodiments of the present invention have been described in detail, the present invention is not limited to the exemplary embodiments and it is obvious to persons skilled in the art that other various exemplary embodiments are possible without departing from the scope of the present invention.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The present invention is also applicable to a program and a program product.

### Supplementary Notes

Regarding the above-described exemplary embodiments, the following supplementary notes will be further disclosed.

(((1)))

An image forming system comprising:
an image forming unit that forms an image on a medium by using toner;
a cyclone capturing unit that includes a suction port through which air containing the toner in the image forming unit is sucked, a tubular container in which the air sucked through the suction port is swirled and of which at least a lower portion is provided with an inclination at which an inner diameter of the container gradually increases from a lower portion side toward an upper portion side, a collection portion that collects the toner, and a gas outlet port for discharge of the air and in which the air is swirled in the container such that the toner is separated from the air due to a centrifugal force, the toner is captured and collected into the collection portion, and the air is discharged through the gas outlet port;
a plurality of cleaning members that are accommodated in the container and that are swirlable together with the air; and
a holding member that is provided at at least a lower end portion of the inclination of the container and that holds the plurality of cleaning members in the container.
   (((2)))

The image forming system according to (((1))),
wherein the cyclone capturing unit includes an air blowing device that causes the air sucked into the container to swirl such that an air stream to be discharged through the gas outlet port is generated.
   (((3)))

The image forming system according to (((2))),
wherein, in the cyclone capturing unit,
the suction port is provided on the upper portion side of the container,
the collection portion is connected to the lower portion side of the container, and
the gas outlet port is provided in a direction intersecting the suction port at an upper portion of the container.
   (((4)))

The image forming system according to any one of (((1))) to (((3))),
wherein the plurality of cleaning members contain a material that is less likely to be charged or a material that is charged with the same polarity as the toner.
   (((5)))

The image forming system according to any one of (((1))) to (((4))),
wherein the plurality of cleaning members include two or more types of cleaning members that are different from each other in at least one of dimension, density, or material.
   (((6)))

The image forming system according to any one of (((1))) to (((5))),
wherein an upper side of the container is also provided with the holding member.
   (((7)))

The image forming system according to (((1))) or (((6))),
wherein the holding member is a partition member including a hole that is larger than a particle diameter of the toner and smaller than a particle diameter of the cleaning members.
   (((8)))

The image forming system according to any one of (((1))) to (((7))),
wherein an upper portion of the container is also provided with an inclination seamlessly connected to the inclination.
   (((9)))

The image forming system according to (((8))),
wherein the inclinations include
   a first inclination that is provided at a position including a lower portion of the container, and
   a second inclination that is provided at the upper portion of the container to be adjacent to the first inclination and that is inclined with respect to a horizontal direction at an angle larger than an angle at which the first inclination is inclined with respect to the horizontal direction.
      (((10)))

The image forming system according to (((2))),
wherein an air blowing rate of the air blowing device is changeable in a stepwise or stepless manner.
   (((11)))

The image forming system according to (((10))),
wherein the air blowing rate of the air blowing device at a time of cleaning of the cyclone capturing unit is different from the air blowing rate of the air blowing device at a time of image formation performed by the image forming unit.
   (((12)))

The image forming system according to (((11))),
wherein the air blowing device intermittently changes the air blowing rate at the time of the cleaning.
   (((13)))

The image forming system according to (((11))),
wherein the air blowing device periodically changes the air blowing rate.
   (((14)))

The image forming system according to (((11))),
wherein the air blowing device changes the air blowing rate before and after an image forming operation performed by the image forming unit.
   (((15)))

The image forming system according to (((11))),
wherein the air blowing device changes the air blowing rate from a high air blowing rate to a low air blowing rate.
   (((16)))

The image forming system according to (((11))), further comprising:
a processor configured to perform cleaning of a wall surface of the cyclone capturing unit in accordance with an amount of the image formation performed by the image forming unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an image forming unit that forms an image on a medium by using toner;
a cyclone capturing unit that includes a suction port through which air containing the toner in the image forming unit is sucked, a tubular container in which the air sucked through the suction port is swirled and of which at least a lower portion is provided with an inclination at which an inner diameter of the container gradually increases from a lower portion side toward an upper portion side, a collection portion that collects the toner, and a gas outlet port for discharge of the air and in which the air is swirled in the container such that the toner is separated from the air due to a centrifugal force, the toner is captured and collected into the collection portion, and the air is discharged through the gas outlet port;
a plurality of cleaning members that are accommodated in the container and that are swirlable together with the air; and
a holding member that is provided at at least a lower end portion of the inclination of the container and that holds the plurality of cleaning members in the container.

2. The image forming system according to claim 1,
wherein the cyclone capturing unit includes an air blowing device that causes the air sucked into the container to swirl such that an air stream to be discharged through the gas outlet port is generated.

3. The image forming system according to claim 2,
wherein, in the cyclone capturing unit,
the suction port is provided on the upper portion side of the container,
the collection portion is connected to the lower portion side of the container, and
the gas outlet port is provided in a direction intersecting the suction port at an upper portion of the container.

4. The image forming system according to claim 1,
wherein the plurality of cleaning members contain a material that is less likely to be charged or a material that is charged with the same polarity as the toner.

5. The image forming system according to claim 1,
wherein the plurality of cleaning members include two or more types of cleaning members that are different from each other in at least one of dimension, density, or material.

6. The image forming system according to claim 1,
wherein an upper side of the container is also provided with the holding member.

7. The image forming system according to claim 1,
wherein the holding member is a partition member including a hole that is larger than a particle diameter of the toner and smaller than a particle diameter of the cleaning members.

8. The image forming system according to claim 6,
wherein the holding member is a partition member including a hole that is larger than a particle diameter of the toner and smaller than a particle diameter of the cleaning members.

9. The image forming system according to claim 1,
wherein an upper portion of the container is also provided with an inclination seamlessly connected to the inclination.

10. The image forming system according to claim 9,
wherein the inclinations include
a first inclination that is provided at a position including a lower portion of the container, and
a second inclination that is provided at the upper portion of the container to be adjacent to the first inclination and that is inclined with respect to a horizontal direction at an angle larger than an angle at which the first inclination is inclined with respect to the horizontal direction.

11. The image forming system according to claim 2,
wherein an air blowing rate of the air blowing device is changeable in a stepwise or stepless manner.

12. The image forming system according to claim 11,
wherein the air blowing rate of the air blowing device at a time of cleaning of the cyclone capturing unit is different from the air blowing rate of the air blowing device at a time of image formation performed by the image forming unit.

13. The image forming system according to claim 12,
wherein the air blowing device intermittently changes the air blowing rate at the time of the cleaning.

14. The image forming system according to claim 12,
wherein the air blowing device periodically changes the air blowing rate.

15. The image forming system according to claim 12,
wherein the air blowing device changes the air blowing rate before and after an image forming operation performed by the image forming unit.

16. The image forming system according to claim 12,
wherein the air blowing device changes the air blowing rate from a high air blowing rate to a low air blowing rate.

17. The image forming system according to claim 12, further comprising:
a processor configured to perform cleaning of a wall surface of the cyclone capturing unit in accordance with an amount of the image formation performed by the image forming unit.
